(19) United States
(12) Patent Application Publication
(10) Pub. No.: US 2015/0106263 A1
(43) Pub. Date: Apr. 16, 2015

(54) METHODS AND SYSTEMS FOR DYNAMICALLY PROCESSING CARD PAYMENT AUTHORIZATION REQUESTS

(71) Applicant: Facebook, Inc., Menlo Park, CA (US)

(72) Inventors: Lee Linden, San Francisco, CA (US); Neville Bowers, San Francisco, CA (US); Ted Zagat, Menlo Park, CA (US)

(73) Assignee: Facebook, Inc., Menlo Park, CA (US)

(21) Appl. No.: 14/051,406

(22) Filed: Oct. 10, 2013

(51) Int. Cl. G06Q 20/40

(52) U.S. Cl. CPC G06Q 20/40
USPC 705/44

(57) ABSTRACT

Exemplary methods and systems for dynamically processing payment authorization requests for gift card purchases. An exemplary method includes maintaining information associated with a gift card, receiving a payment authorization request for the gift card from a particular merchant, detecting a trigger associated with the received payment authorization request, and sending, based on the detected trigger, a response to the payment authorization request. Corresponding methods and systems are also disclosed.

### BACKGROUND OF THE INVENTION

1. The Field of the Invention

One or more embodiments of the present invention relate generally to processing and responding to payment authorization requests. More specifically, one or more embodiments of the present invention relate to systems and methods of dynamically responding to gift card payment authorization requests.

2. Background and Relevant Art

Advances in electronic communications technologies have interconnected people and allowed for better distribution of information than ever before. To illustrate, personal computers, handheld devices, mobile phones, and other electronic access devices are increasingly being used to communicate and share information with other users. In particular, the advent of social networking systems and services allow users to connect, communicate, or share information and content (e.g., video, audio, photographs, and/or multimedia).

These advances in electronic communications technologies have also facilitated financial transactions. In particular, electronic payment networks (e.g., electronic credit card networks) may facilitate the almost instantaneous authorization of purchases made by users with payment cards (e.g., credit cards and/or a gift cards). However, a number of disadvantages remain with respect to card-based purchases, purchase authorizations, and purchase settlement.

As one example, the process of instituting and applying sales promotions remains a largely manual process. Traditionally, a merchant or manufacturer would issue coupons that a user could provide at the point of sale in order to qualify for a promotional discount. These coupons are typically physical (e.g., paper) and must be manually applied at the point of sale by a sales clerk (e.g., by scanning the coupon or by manually inputting the corresponding discount into a point-of-sale system). Once a merchant accepts a coupon, the merchant may then be required to take additional steps in order to complete the redemption process. For example, a coupon provider may require that the merchant return (e.g., by mail) the coupon, which the coupon provider will then process and return compensation back to the merchant. This process is antiquated, time consuming, and presents a drain on resources for merchants and manufacturers alike. These disadvantages are magnified by the fact that millions of coupons are issued and processed each year.

With the introduction of social networking systems and services, merchants have begun to provide promotions associated with social networking activity of current and potential customers. For example, a merchant may provide customers with a discount if the customers use a social networking service to share information about the merchant. To illustrate, in exchange for a user using a social networking system to “like” a merchant or “check-in” at a location associated with the merchant, the merchant may provide the user with a promotional discount on their next purchase. However, it is difficult for merchants to verify such social networking activity and/or to prevent providing redundant discounts to the same customer. Furthermore, these social networking promotions are still largely manual in nature and must be applied by a sales clerk at the point of sale.

A number of additional disadvantages exist with specific respect to gift card transactions. Gift cards have become increasingly popular over the past decide, with annual gift card purchases accounting for tens of billions of dollars in transactions annually. Gift cards may operate in a manner similar to traditional credit cards. In particular, gift cards may be plastic cards with a barcode or magnetic strip that may be read by an electronic credit card machine. In addition, gift card purchases may be authorized using one or more established bank or credit card networks (e.g., the Visa/MasterCard™ network, the Discover™ network, the American Express™ network, etc.). However, gift cards management is typically rigid and fails to dynamically account for a user's or a merchant's needs. As one example, traditional gift cards fail to provide users with the option to spend more than a stored value on the gift card. Thus, users are forced to make purchases for less than the stored value, or split the payment between the gift card and another payment mechanism (e.g., a credit card, cash).

Accordingly, there are a number of considerations to be made in the management and processing of card-based financial transactions.

### BRIEF SUMMARY OF THE INVENTION

Embodiments of the present invention provide benefits and/or solve one or more of the foregoing or other problems in the art with methods and systems for increasing the ease and efficiency of processing payment authorization. For example, the principles described herein help reduce the time and resources necessary to implement and process promotional offers for card merchants and users. Furthermore, the present invention may increase the flexibility of card-based purchases.

In some embodiments, a method according to the present disclosure can comprise maintaining information associated with a gift card, receiving a payment authorization request for the gift card from a particular merchant, detecting a trigger associated with the received payment authorization request, and sending, based on the detected trigger, a response to the payment authorization request.

In additional or alternative embodiments, a method according to the present disclosure can comprise maintaining information associated with a gift card. The gift card can include or otherwise be associated with one or more stored values associated with one or more merchants. The method can comprise receiving a payment authorization request for the gift card from a particular merchant and that specifies a payment amount for a purchase being made with the gift card. The method can further comprise identifying a promotion associated with the payment authorization request and determining whether one or more conditions associated with the promotion have been satisfied. If the one or more conditions have been satisfied, the method can comprise applying a corresponding promotional value towards the purchase. Finally, the method can comprise sending a response to the payment authorization request.

In yet further embodiments, a method according to the present disclosure can comprise maintaining information associated with a gift card. The gift card can include or otherwise be associated with one or more stored values associated with one or more merchants. The method can comprise receiving a payment authorization request for the gift card from a particular merchant and that specifies a payment amount for a purchase being made with the gift card. The method can further comprise determining that the payment amount exceeds a stored value associated with the payment authorization request. If the one or more overspend conditions have been satisfied, the method can comprise applying an overspend value towards the purchase. Finally, the method can comprise sending a response to the payment authorization request.

Additional features and advantages of the present invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1A illustrates an exemplary gift card authorization system according to principles described herein.

FIG. 1B illustrates a schematic diagram for processing a gift card transaction according to principles described herein.

FIG. 2 illustrates an exemplary implementation of the system of FIG. 1A according to principles described herein.

FIG. 3 illustrates another exemplary implementation of the system of FIG. 1A according to principles described herein.

FIG. 4 illustrates an exemplary method of dynamically processing payment authorization requests according to principles described herein.

FIG. 5 illustrates another exemplary method of dynamically processing payment authorization requests according to principles described herein.

FIG. 6 illustrates a further exemplary method of dynamically processing payment authorization requests according to principles described herein.

FIG. 7 illustrates a block diagram of an exemplary computing device according to principles described herein.

FIG. 8 illustrates an example network environment of a social networking system according to principles described herein.

### DETAILED DESCRIPTION

Exemplary methods and systems for dynamically processing card-based payment authorization requests are disclosed herein. In particular, the present application details exemplary embodiments of a system and method for dynamically processing payment authorization requests for gift cards in accordance with one or more detected triggers. The triggers may be conditional promotions, overspend authorizations, and/or any other suitable feature provided to gift card users. Among other benefits, the principles described herein allow merchants and manufacturers to implement and carry out promotions without the time and resource costs of traditional coupon-based promotions. In addition, the present invention allows for increased overspend flexibility and options with respect to gift card transactions. Although the present invention is explained with particular reference to gift cards, one will appreciate that the principles described herein are equally applicable to processing authorization requests for any other types of transactions (e.g., credit card transactions).

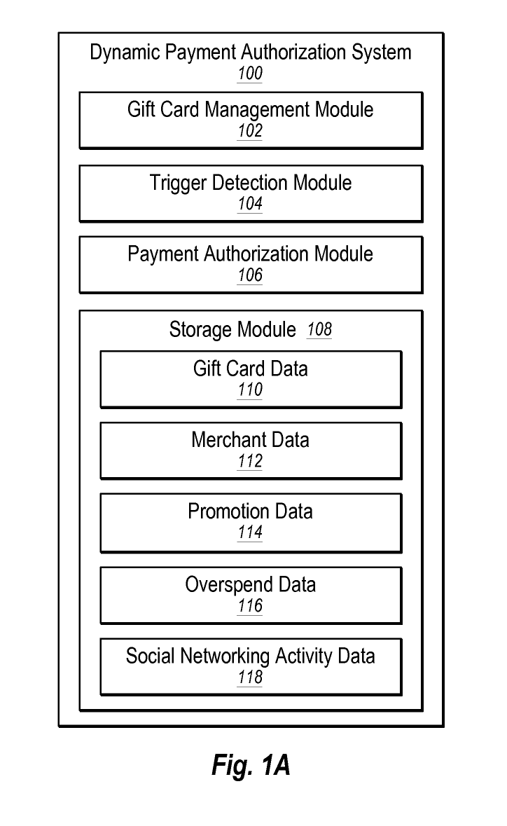

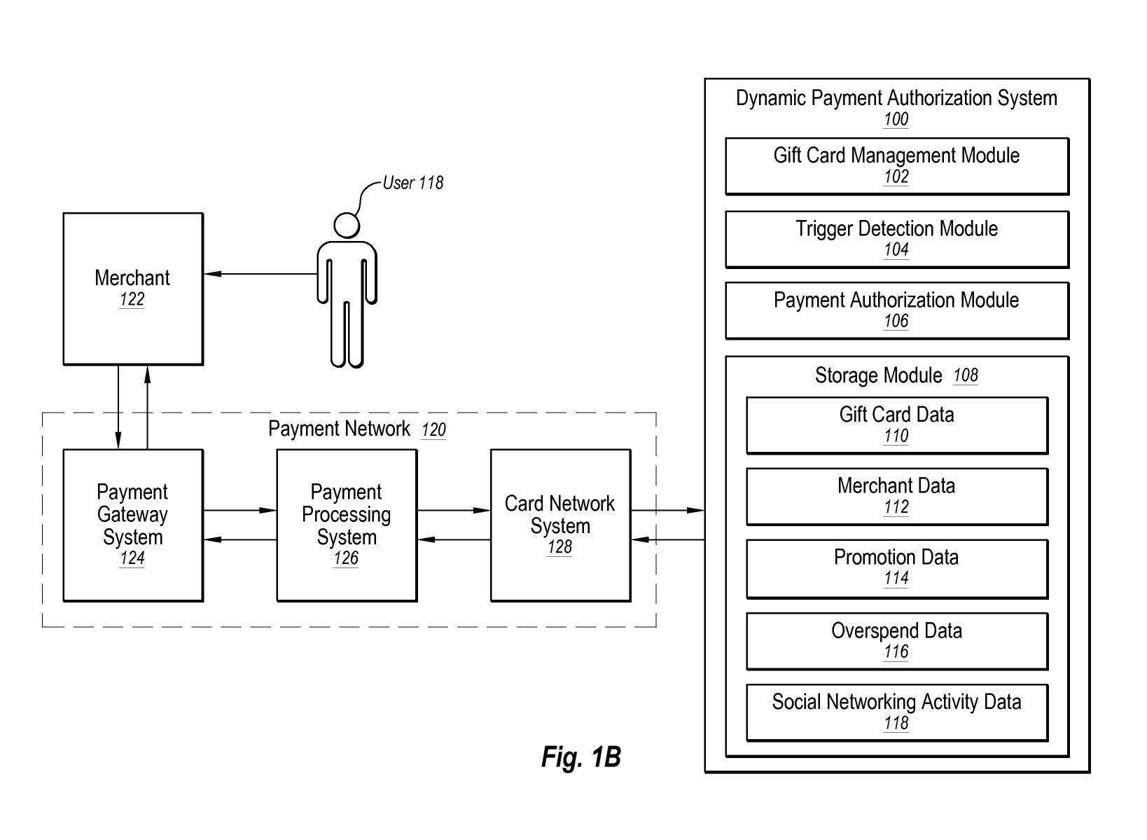

FIG. 1A illustrates an exemplary dynamic payment authorization system 100 (or simply “system 100”). System 100 may be associated with an issuer of gift cards and may be configured to manage and respond to payment authorization requests associated with the gift cards. In one or more embodiments, system 100 may be linked to and/or provided by way of a social networking system (e.g., FACEBOOK™). In particular, a social networking system may issue one or more gift cards (e.g., physical gift cards or virtual gift cards) to users of the social networking system, facilitate gifting among users of the social networking system, manage values stored on the issued gift cards, manage transactions associated with the issued gift cards, and/or perform one or more steps associated with system 100. As will be described in more detail below, system 100 may be configured to enhance the efficiency of managing gift cards and, in particular, processing gift card payment authorizations.

System 100 may include, but is not limited to, a gift card management module 102 (or simply “management module 102”), a trigger detection module 104, a payment authorization module 106 (or simply “authorization module 106”), and a storage module 108, which may be in communication with one another using any suitable communication technologies. It will be recognized that although modules 102-108 are shown to be separate in FIG. 1A, any of modules 102-108 may be combined into fewer modules, such as into a single module, or divided into more modules as may serve a particular implementation.

As will be described in more detail below, management module 102 may be configured to manage information associated with one or more gift cards. The managed gift cards may be physical (e.g., plastic) or virtual gift cards that have been issued to users. The gift cards may allow corresponding users to make purchases at designated merchants using stored values (or “gifted values”) on the gift cards.

For each gift card managed by management module 102, management module 102 may maintain information regarding one or more stored values and one or more merchants corresponding to the stored values (e.g., merchants where the stored values may be used). In one or more embodiments, the gift cards may be multi-merchant gift cards. In other words, each gift card may be capable of storing a plurality of values, with each value associated with one of a plurality of different merchants. In particular, each stored value may be redeemable only at a particular merchant or group (e.g., chain) of merchants. To illustrate, a particular gift card may include a 1st stored value associated with and redeemable at Merchant A, a 2nd stored value associated with and redeemable at Merchant B, and a 3rd stored value associated with and redeemable at Merchant C. As one will appreciate, management module 102 may manage a gift card storing any number of values associated with any suitable number of merchants.

Each gift card managed by management module 102 may be tied to a particular user account of a user to which the gift card is issued. In particular, the user may set up an account associated with the gift card to facilitate the management of the gift card. In one or more embodiments, the gift card may be linked to a pre-existing account of the user. For example, the gift card may be linked to a social networking account of the user. In additional or alternative embodiments, a gift card may be tied to a user account using a unique card token. If the user loses his/her gift card, the user can utilize the linked account to deactivate the lost gift card and obtain a new gift card without losing the value stored on the gift card. Accordingly, the user is not subject to the typical risks associated with lost gift cards.

As mentioned above, each gift card managed by management module 102 may be capable of storing a plurality of values. In some embodiments, a plurality of stored values on a gift card may be representative of a plurality gifts given to the user. For example, a number of different donors may give gifts to a user and management module 102 may be configured to manage the gifts and store the gifts on the user's gift card. In some embodiments, management module 102 may consolidate the values of all the gifts that the user receives and make the values available for use by the user at the corresponding merchants. For example, management module 102 may consolidate all gifts for a particular merchant or group (e.g., chain) of merchants, and make the consolidated amount available for use by the user at the particular merchant or group of merchants. The process of gift value consolidation can be repeated for each merchant associated with stored values on the gift card. Thus, all gifts can be combined and made available for use by the user at the corresponding merchants. Alternatively, the combined values may be made available for use at any merchant. In other words, the values stored on the gift card may not be associated with or limited to use at any particular merchant.

In some examples, the gifts stored on a gift card may originate by way of a social networking service. In particular, a user's social networking connections (e.g., “friends”) may give gifts to the user to be stored on the user's gift card. Management module 102 may be configured to facilitate such gifting and/or manage the use of such gifts. As such, in one or more embodiments, management module 102 may be linked to and/or implemented within a social networking system, as already mentioned above.

Each gift card managed by management module 102 may include one or more stored values. As used herein, “stored values” may refer to a value that has been gifted to a user and that is stored on the user's gift card. In addition, stored values may be values that are available for use by a user without restrictions other than being restricted to the particular merchants to which the stored values apply.

In addition or in the alternative to stored values, management module 102 may be configured to maintain information associated with one or more promotional values stored on a gift card. In particular, management module 102 may maintain a table or other data structure that associates a particular card user (e.g., a user identifier) and/or gift card (e.g., card number) with one or more promotions for which the card user is eligible along with the terms and conditions of the promotions. As used herein, “promotional values” may refer to any value that is available to a user by way of a promotion. Promotional values may be a fixed amount (e.g., $5), a percentage discount (e.g., 10%), a percentage discount with a discount cap (e.g., 20% up to a total available discount of $50), an item-based discount (e.g., buy 1 get 1 free), or other promotional value. A promotional value may be restricted to terms and conditions associated with a corresponding promotion. For example, a merchant may utilize management module 102 to initiate a promotion, identify available promotional values, and/or specify one or more conditions for the use of the promotional values. For example, conditions of a promotion may indicate that a promotional value may only be available: on certain days or at certain times (e.g., only on Wednesdays between noon and 4 p.m.), after the user has already made a purchase of a minimum qualifying amount (e.g., only on purchases of $50 or more), before a particular expiration date, after a certain number of purchases (e.g., after a user's tenth purchase at a particular merchant), after completion of some event by the user (e.g., after completing a social networking activity), at a particular geographic location (e.g., at a particular merchant location or within a particular geographic region), for particular target users (e.g., a target demographic), and/or based on any other suitable conditions.

Promotions, and the conditions thereof, may be specified by a merchant or other sponsor of the promotion. Specifically, the merchant may utilize management module 102 to initiate, fund, and/or set conditions for a promotion. In some embodiments, the merchant may utilize management module 102 to actively manage and track the progress of a promotion (e.g., by way of an online management portal). Accordingly, the merchant can more efficiently and easily initiate, track, adapt (e.g., by changing promotion conditions), and/or otherwise manage promotions. Further, the merchant may utilize social networking information to specifically target users that the merchant is interested in obtaining as customers. For example, the merchant may specify one or more user characteristics to target with a particular promotion. Management module 102 can obtain user profile information associated with potential users in order to identify a target group of users having the specified characteristics. In some examples, the user profile information may be obtained by way of a social networking system. In other words, social networking profiles of the users may be utilized to identify users having the target characteristics (e.g., users having a particular set of interests, living in a certain area, and/or falling within a certain demographic category). Accordingly, the merchant may be able to provide promotions to a group, for which the promotion is most likely to be effective. In some embodiments, management module 102 may facilitate management of promotions by way of a promotion management web portal. Information made available to promotion sponsors may be updated in real time based on payment authorization requests received by system 100. Accordingly, promotion sponsors can actively track and manage the employment and success of their promotions, using real-time feedback from management module 102.

As mentioned above, conditions for a particular promotion may require that a user complete a certain social networking activity in order to qualify for the particular promotion. For example, a particular promotion may require that a user utilize a social networking system to “like” or otherwise express approval of a particular promotion sponsor (e.g., to “like” a website or social networking page associated with a particular merchant or a particular manufacturer), check in to a location associated with the particular promotion sponsor, share content (e.g., an image, an article, or other content) associated with the particular promotion sponsor, or perform any other suitable social networking activity. To illustrate, a particular promotion may require that a user use a social networking system to “like” the promotion sponsor's website and to check in at the promotion sponsor's physical location with a plurality of the user's social networking contacts (e.g., “friends”) in order to qualify for the promotion. Thus, a promotion sponsor (e.g., merchant) may utilize a promotion to gain user-to-user advertising by way of the social networking system.

To facilitate the foregoing, management module 102 may be configured to track and/or facilitate the social networking activities of users. For example, management module 102 may be implemented within or receive information from one or more social networking systems. Further, management module 102 can analyze social networking activities of the users and/or provide information to the one or more social networking systems regarding the users' interactions with management module 102. Management module 102 may then utilize the social networking activity to determine whether the users are eligible for promotions or other services managed by management module 102.

In some embodiments, a user may configure use of a gift card to automatically initiate social networking activity on behalf of the user. To illustrate, the user may configure one or more settings associated with the gift card and/or a social networking profile associated with the user to automatically check the user in to a location where the user is using their gift card. Such automated settings may facilitate the user's satisfaction of one or more conditions associated with a promotion. Additionally or alternatively, the automated settings may be conditioned on terms and conditions associated with a promotion. For example, if a promotion requires a particular social networking activity, the automated settings may automatically initiate the particular social networking activity on behalf of the user in order to satisfy the terms and conditions of the promotion.

Once conditions associated with a promotion are satisfied, management module 102 may make a corresponding promotional value available for use by a user. In particular, management module 102 may be configured make the promotional value available for the purchase by the user.

In some embodiments, management module 102 may be configured to apply one of a number of potential promotional values based on a prioritization of the promotional values. For example, if a user qualifies for a plurality of promotions, management module 102 may determine which of a plurality of available promotional values to apply (e.g., if the promotional values cannot be combined). In some embodiments, management module 102 may select a promotional value to apply based on values of available promotional values (e.g., to apply the largest available promotional value first), a prioritization of promotions (e.g., based on a prioritization provided by a promotion sponsor), expiration dates of available promotional values (e.g., to prioritize a promotion that will be expiring first), initiation dates of available promotional values (e.g., in accordance with a “First In First Out” prioritization), and/or any other suitable characteristics associated with the available promotional values. Additionally or alternatively, management module 102 may select the promotional value that provides the greatest benefit to the user at the time of the purchase. To illustrate, if a user satisfies the conditions associated with both a promotional value of $10 and a separate promotional value of $20, and the promotional values are mutually exclusive (e.g., cannot be combined together), management module 102 may choose to apply the promotional value of $20 to provide the user with the greatest benefit.

Management module 102 may prioritize a promotional value over a stored value. For example, once conditions associated with a particular promotional value are met, management module 102 may apply the full value of the promotional value to a corresponding purchase before beginning to apply a stored value to the remainder. Thus, the user obtains the full value of the promotion prior to deducting amounts from stored values on the user's gift card. To illustrate, if a user making a purchase of $100 has a gift card with a stored value of $100 and a promotional value of $10 (for which all conditions have been satisfied), management module 102 may apply the promotional value of $10 to the purchase prior to utilizing the stored value of $100 to cover the remaining $90 of the purchase, thereby leaving the user with a stored value of $10 for later use.

Although, like stored values, promotional values may originate from donors (e.g., in the form of promotional gifts). Promotional values also may originate from and/or be sponsored by promotion sponsors (e.g., merchants or manufacturers). In particular, in conjunction with a promotion sponsored by a merchant, the merchant may fund the promotional values associated with the promotion. In turn, management module 102 may store the promotional values on the gift cards of one or more users that are eligible for the promotion. The funds corresponding to the promotional values may be received from the promotion sponsor at the time of the promotion or later on (e.g., as part of a redemption/settlement process). For example, when a promotion sponsor initiates a promotion to be managed by system 100, the promotion sponsor may wire or otherwise transfer the funds necessary for the upcoming promotion to a bank account associated with system 100. These funds may then be selectively applied by system 100 as the promotional values are redeemed by users eligible for the promotion. In particular, the amounts necessary to cover the promotional values may be used by system 100 to cover the promotional portions of qualifying purchases made by card users. Once the promotion has concluded, any remaining unused funds may be returned to the promotion sponsor. In additional or alternative embodiments, the funds corresponding to a promotional value may be transferred directly from a promotion sponsor to a merchant where the promotional value was redeemed, thereby bypassing system 100.

In addition to managing promotions, management module 102 may be configured to manage overspend authorizations. In particular, management module 102 may provide users with an option to utilize their gift card to make a purchase that exceeds a stored value and/or a promotional value stored on the gift card. For example, management module 102 may be configured to store an overspend value on a gift card that may be used to cover any overspend amounts (e.g., amounts of purchases that exceed corresponding stored values). The overspend value may be funded by a user (e.g., by depositing the value onto the gift card using a separate credit card or transfer from a bank account associated with the user) of the gift card and may be utilized by management module 102 to authorizing overspending for the gift card. Once an overspend value has been depleted, the user may choose to replenish the overspend value, thereby continuing to benefit from the overspend feature. Additionally or alternatively, a user may provide an alternative funding source (e.g., a credit card, a bank account) that may be used to cover overspend amounts. In particular, upon a determination that an overspend authorization is necessary (e.g., that a purchase exceeds a corresponding stored value), system 100 may issue a payment authorization request to an alternative funding source (e.g., the user's credit card) to cover the overspend amount. In some examples, system 100 may issue and receive a response to a payment authorization request to an alternative funding source within the time necessary to respond to a payment authorization request received by system 100. The funds may be received from the alternative funding source by an issuing bank associated with system 100 and then passed on to a bank associated with the merchant to settle the authorized purchase. Alternatively, the funds may be provided directly to the merchant's bank from the alternative funding source. Accordingly, system 100 may authorize the overspend amount without the need to delay or reject the received payment authorization request.

A user of a gift card may also set one or more conditions for overspend authorizations associated with the gift card. For example, the user may restrict an amount of overspend authorizations, may restrict a frequency of overspend authorizations, may restrict a period of time for overspend authorizations, may restrict overspend authorizations to a particular merchant or group of merchants, and/or may restrict any other aspect related to overspending. Utilizing overspend authorization information received from a user, management module 102 may selectively authorize overspending for the user's gift card in accordance with funding information and/or other information provided by the user. Thus, the user is able to expand the use and flexibility of his/her gift card.

In some embodiments, overspend authorizations may be restricted to purchases and/or merchants for which a gift card already includes stored values. To illustrate, a user may not be allowed to utilize an overspend value to cover a purchase for which the gift card doesn't already include a relevant stored value.

To illustrate the overspend authorization process, once system 100 determines that a received payment authorization request exceeds a stored value and/or a promotional value on a gift card, and once an overspend has been authorized, management module 102 may apportion a purchase accordingly. For example, management module may utilize a stored value to cover a first portion of the purchase, a promotional value (if available) to cover a second portion of the purchase, and an overspend value or alternative funding source to cover any remaining portion (e.g., overspend amount) of the purchase.

Management module 102 may utilize information associated with merchants in order to dynamically identify merchants associated with received payment authorization requests. By identifying a merchant associated with a payment authorization request, management module 102 is able to identify and apply any values from a gift card (e.g., stored values, promotional values) associated with the merchant.

In one or more embodiments, management module 102 may maintain one or more unique merchant identifiers (“Merchant IDs” or “MIDs”) associated with each merchant. A MID may comprise a unique string of numbers or other characters that uniquely identifies a particular merchant. In some examples, a single MID may identify a group of merchants. For example, a single MID may be shared by each merchant in a chain of merchants having a common business model or owned/controlled by a common parent entity. Additionally or alternatively, a merchant identifier may be shared by two separate merchants, for example two merchants that share a common trait, such as a common location (e.g., a grocery store and coffee shop within the grocery store).

System 100 may utilize the known merchant identifiers to identify merchants from which payment authorization requests are sent. A payment authorization request can comprise various pieces of information. For example, the payment authorization request may include a card number to be charged, a payment amount to be authorized, a soft descriptor (including a merchant name, city, zip code, etc.), and a merchant identifier.

Management module 102 may associate each stored value, promotional value, and/or overspend value on a gift card with a corresponding merchant identifier. Accordingly, when a payment authorization request—including a merchant identifier—is received from a particular merchant, management module 102 may utilize the merchant identifier to identify the particular merchant and to identify values stored on the gift card that are associated with the particular merchant identifier (e.g., that may be used to cover purchases from the particular merchant).

As mentioned above, system 100 may also include a trigger detection module 104. Trigger detection module 104 may be configured to detect one or more triggers associated with a payment authorization request. In particular, trigger detection module may be configured to determine whether one or more conditions associated with the application of a stored value, a promotional value, and/or an overspend value have been met.

For example, trigger detection module 104 may be configured to detect a trigger associated with a promotion being offered through system 100. In particular, trigger detection module 104 may analyze information associated with a user, a gift card issued to a user, a payment authorization request for the gift card, and/or a promotion available to the user, and then determine whether one or more conditions specified by the promotion have been satisfied. To illustrate, if conditions associated with a particular promotion require that a corresponding purchase must reach a minimum purchase amount (e.g., $75), and that the user must perform a particular social networking activity (e.g., utilize a social networking system to check in to a particular merchant's location with two or more friends), prior to applying a corresponding promotional value (e.g., a 20% discount), trigger detection module 104 may be configured to access information from the payment authorization request to determine whether the minimum purchase amount has been met and access information from a social networking system to determine whether the social networking activity has been performed by the user. If the conditions have been satisfied, trigger detection module 104 may provide a corresponding response to one or more other modules of system 100 (e.g., to management module 102 and/or authorization module 106). Accordingly, for example, authorization module 106 is able to determine whether to authorize a particular payment, and management module 102 is able to determine whether or not to apply a particular promotional value to the payment, based on the trigger detected by trigger detection module 104.

In additional or alternative embodiments, trigger detection module 104 may be configured to detect one or more triggers associated with an overspend authorization. For example, trigger detection facility 104 may analyze a payment authorization request, a corresponding stored value on a gift card, any available promotional value(s) on the gift card, any available overspend value on the gift card, and/or any available overspend alternative funding information for the gift card in order to determine whether one or more conditions associated with an overspend authorization have been met. To illustrate, trigger detection module 104 may, upon determining that an overspend authorization is necessary (e.g., determining that a combination of a relevant stored value and any available promotional values is less than the purchase amount), determine whether an overspend value on a gift card is sufficient to cover an overspend amount, and determine whether one or more restrictions associated with the overspend value have been met. If the overspend value is sufficient to cover the overspend authorization and if any restrictions associated with the user of the overspend value have been met, trigger detection module 104 may provide a corresponding response to one or more other modules of system 100 (e.g., to management module 102 and/or authorization module 106). Accordingly, for example, authorization module 106 is able to determine whether to authorize a particular payment, and management module 102 is able to determine whether or not to apply a particular overspend value, based on the trigger detected by trigger detection module 104.

The steps, analysis, and determinations of trigger detection module 104 may occur at any suitable time. In some embodiments, at least a portion or all of the trigger detection process may occur after receipt of a corresponding payment authorization request and/or within the time available to respond to the payment authorization request. For example, trigger detection module 104 may be configured to dynamically detect triggers in response to a payment authorization request and before a response to the payment authorization request is required. Accordingly, trigger detection module 104 can perform real-time, back end trigger detections associated with the application of one or more promotions and/or overspend authorizations.

As mentioned above, system 100 may also include authorization module 106. Authorization module 106 may be configured to respond to payment authorization requests received by system 100. In particular, authorization module 106 may be configured to respond to payment authorization requests based on information managed by management module 102 and/or triggers detected by trigger detection module 104. To illustrate, authorization module 106 may identify a purchase amount associated with a payment authorization request and then determine whether the gift card includes enough value to cover the purchase amount. For example, authorization module 106 may combine a relevant stored value (e.g., a stored value for the merchant that issued the payment authorization request) and/or an available promotional value to arrive at a combined available value. Authorization module 106 may then determine whether the combined available value is sufficient to cover the purchase amount (e.g., by comparing the combined available value to the purchase amount). If the combined available value is sufficient to cover the purchase amount, authorization module 106 may approve a payment of the purchase amount. If the combined value is insufficient to cover the purchase amount, authorization module 106 may reject the payment of the purchase amount. In any event, authorization module 106 may provide a corresponding response to the payment authorization request. For example, authorization module 106 may send the response by way of a credit card network to a merchant that sent the payment authorization request.

In one or more embodiments, an available promotional value may facilitate authorization of a payment that exceeds a stored value on a gift card. To illustrate, if system 100 receives a payment authorization request for a $50 purchase from a merchant using a gift card, and the gift card only includes a stored value of $40 for the merchant, the payment authorization request would typically be declined. However, authorization module 106 may be configured to apply one or more promotional values to cover the remaining portion of the purchase amount. For example, if a promotional value of $10 is available for the merchant (e.g., based on the satisfaction of one or more corresponding promotion conditions), authorization module 106 may utilize the promotional value of $10 to cover the deficiency between the purchase amount and the stored value. In particular, authorization module 106 may combine the stored value of $40 and the promotional value of $10 to cover the purchase amount of $50, and then send a response approving the purchase. In similar fashion, authorization module 106 may utilize an overspend value, independent of or in combination with a stored value and/or a promotional value, to authorize a requested purchase.

To illustrate the payment authorization process in more detail, FIG. 1B includes a schematic diagram for processing payment authorization requests in accordance with principles described herein. In particular, FIG. 1B illustrates an example process for authorizing a payment authorization request initiated by a user 118 and received by way of a payment network 120. Once user 118 initiates a transaction with a merchant 122 using the user's gift card, either by physically swiping the gift card at the merchant 122's physical point of sale (“POS) system or by initiating an e-commerce transaction by providing the gift card information to the merchant 122 through an e-commerce application (e.g., the merchant 122's website), the merchant may send the transaction to a payment gateway system 124 for processing. The payment gateway system 124 may then pass the transaction to a payment processing system 126 used by the merchant 122's acquiring bank. Based upon the type of the card used by the user (e.g., Visa/MasterCard/AmericanExpress/Discover), the payment processing system 126 used by the merchant 122's acquiring bank can transmit the transaction to an appropriate card network system 128. The card network system 128 can then pass a payment authorization request to system 100 (e.g., by way of an issuing bank associated with system 100).

Upon receiving the payment authorization request, system 100 may process the payment authorization request as described in more detail above. For example, management module 102 may maintain information regarding user 118 and a gift card associated with user 118. In particular, management module 102 may maintain information regarding one or more values (e.g., stored values, promotional values, overspend values) stored on the gift card, including one or more values available for use at merchant 122. Trigger detection module 104 may then detect one or more triggers associated with the received payment authorization request. For example, trigger detection module 104 can detect one or more triggers for a particular promotional value stored on the gift card and available for use at merchant 122. Thereafter, authorization module 106 either approves or declines the transaction, and sends the decision back to the card network system 128. Additionally or alternatively, authorization module 106 can provide a partial authorization (e.g., equal to a stored value and/or promotional value available on the gift card) if the funds available on the gift card do not completely cover the purchase amount. The decision is then transmitted from the card network system 128 back to the acquiring bank's preferred payment processing system 126. The payment processing system 126 can then forward the decision back to the payment gateway system 124, which may store the details concerning the transaction and the decision, and then pass the decision back to the merchant 122.

System 100 can also perform settlement tasks. In particular the payment gateway system 124 can submit a daily settlement batch of captured transactions to the acquiring bank via the acquiring bank's preferred payment processing system 126. The payment processing system 126 then passes the settlement batch to a server of the acquiring bank, which deposits the funds from the transaction into the merchant's account. Then, the acquiring bank sends a request for funds in satisfaction of this order to the payment processing system 126, which passes the funding request to the appropriate card network system 128, which in turn passes the funding request to the issuing bank associated with system 100. Then, system 100 posts the transaction to the user's account and passes a release of the funds to the card network system 128, which are then passed to the payment processing system 126 and then to the acquiring bank associated with the merchant 122.

As mentioned above, authorization module 106 in some embodiments may issue only a partial authorization to a payment authorization request rather than completely denying the request if only partial funds are available. This procedure may be facilitated by way of a social networking system. In particular, the social networking system may notify the user of the partial authorization request, who can then inform the merchant to split the purchase between multiple funding sources, thus making the checkout procedure easier and more seamless despite the insufficient funds on the gift card to cover the entire purchase.

Storage module 108 may be configured to maintain gift card data 110 representative of information associated with one or more gift cards (and/or corresponding users), merchant data 112 representative of information associated with one or more merchants, promotion data 114 representative of information associated with one or more promotions, overspend data 116 representative of information associated with one or more overspend authorizations, and/or social networking activity data 116 representative of information associated with one or more social networking activities. Storage module 108 may be configured to maintain additional or alternative data as may serve a particular implementation. As an example, storage module 108 may store one or more data tables and/or other data structures that associate, for example, a merchant with any or all of the following information: one or more merchant identifiers associated with the merchant, a promotion comprising one or more promotional conditions, one or more user identifiers for users eligible for the promotion, one or more gift card numbers for gift cards eligible for the promotion, one or more gift cards having values stored thereon that are redeemable at the merchant, different locations associated with the merchant, funds provided by the merchant, and any other suitable information associated with the merchant or a gift card program, such as the different types of information disclosed herein. Additionally or alternatively, storage module 108 may store one or more data tables and/or other data structures that associate a gift card with any or all of the following information: a gift card number for the gift card, a user identifier associated with a user of the gift card, one or more stored values that can be redeemed using the gift card, one or more merchants associated with values stored on the gift card, one or more promotions eligible to the user of the gift card, an alternative funding source associated with the gift card, social networking information associated with a user of the gift card, and any other suitable information, such as disclosed herein.

In accordance with the foregoing principles, and as will be explained in more detail below, system 100 is configured to dynamically process payment authorization requests in a number of ways. In particular, system 100 is capable of dynamically applying promotions and/or overspend authorizations in a manner that is seamless and imperceptible by a merchant or user at the point of sale. By so doing, system 100, for example, remedies a number of inefficiencies and other disadvantages associated with the management of promotions and overspend authorizations. System 100 also provides a number of other advantages that will be apparent to one of skill in the art based on the principles described herein.

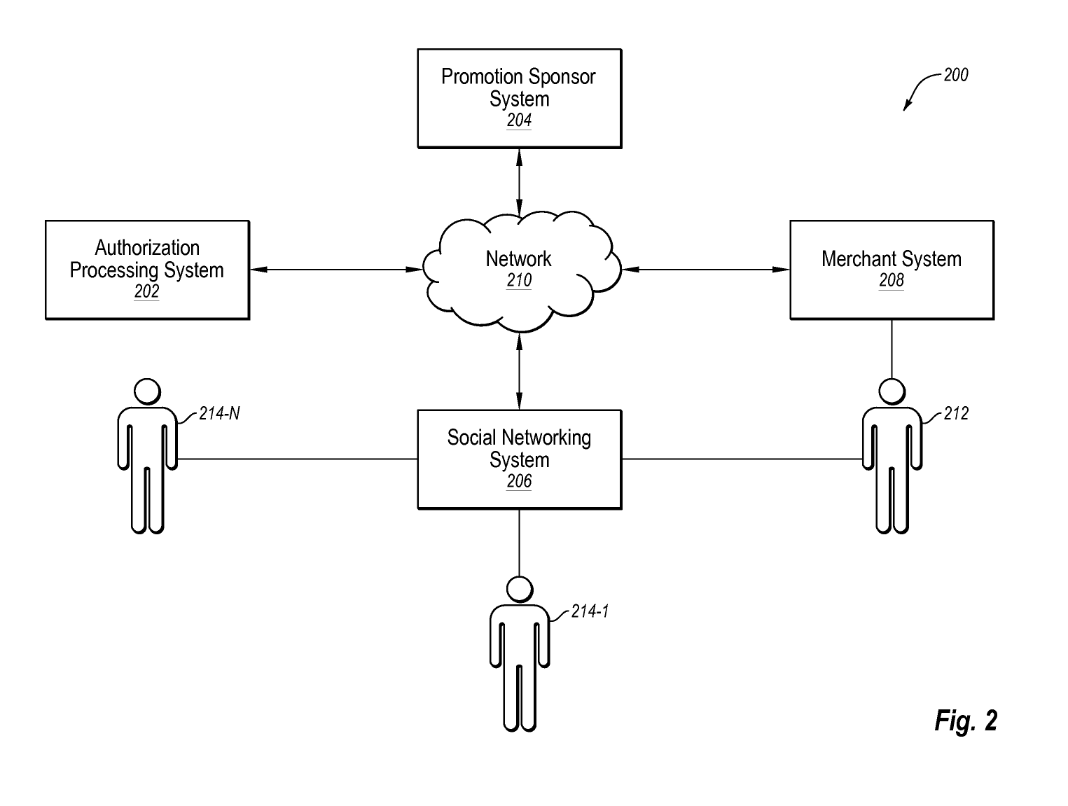

FIG. 2 illustrates an exemplary implementation 200 of system 100 wherein an authorization processing system 202 is communicatively coupled to a promotion sponsor system 204, a social networking system 206, and a merchant system 208. As will be described in more detail below, management module 102, trigger detection module 104, authorization module 106, and storage module 108 may each be implemented on one or both of authorization processing system 202 and social networking system 206. In particular, authorization processing system 202 and/or social networking system 206 may be configured to perform any of the features described above with respect to system 100.

Authorization processing system 202, promotion sponsor system 204, social networking system 206, and/or merchant system 208 may communicate using any communication platforms and technologies suitable for transporting data and/or communication signals, including known communication technologies, devices, media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, wireless communication technologies, in-band and out-of-band signaling technologies, and other suitable communications networks and technologies.

In certain embodiments, authorization processing system 202, promotion sponsor system 204, social networking system 206, and/or merchant system 208 may communicate via a network 210, which may include one or more networks, including, but not limited to, wireless networks (Wi-Fi networks), (e.g., wireless communication networks), mobile telephone networks (e.g., cellular telephone networks), closed communication networks, open communication networks, satellite networks, navigation networks, broadband networks, narrowband networks, the Internet, local area networks, and any other networks capable of carrying data and/or communications signals between authorization processing system 202, promotion sponsor system 204, social networking system 206, and/or merchant system 208. Communications between authorization processing system 202, promotion sponsor system 204, social networking system 206, and merchant system 208 may be transported using any one of the above-listed networks, or any combination or sub-combination of the above-listed networks.

While FIG. 2 shows authorization processing system 202, promotion sponsor system 204, social networking system 206, and merchant system 208 communicatively coupled via network 210, it will be recognized that authorization processing system 202, promotion sponsor system 204, social networking system 206, and/or merchant system 208 may be configured to communicate one with another in any other suitable manner (e.g., via a direct connection).

In one or more embodiments, authorization processing system 202 may be configured to dynamically manage and respond to payment authorization requests for a user 212 of social networking system 206. To illustrate, authorization processing system 202 may be configured to maintain information associated with a gift card issued to user 212, manage one or more aspects of the gift card, receive promotion information from promotion sponsor system 204, receive social networking information from social networking system 206, receive payment authorization requests from merchant system 208, and/or dynamically process the received payment authorization requests in accordance with the available information.

In one or more embodiments, authorization processing system 202 may be configured to facilitate promotional offers to user 212. For example, authorization processing system 202 may receive information associated with one or more promotions available to user 212 from promotion sponsor system 204. Promotion sponsor system 204 may be associated with any suitable promotion sponsor (e.g., a manufacturer, a merchant) that wants to provide promotions to users of social networking system 206. In one or more embodiments, the information received by authorization processing system 202 from promotion sponsor system 204 may include a promotional value for the offered promotion and one or more conditions that must be satisfied before the promotional value becomes available for use by user 212.

A promotion initiated through promotion sponsor system 204 may be associated with merchant system 208 (e.g., the promotion may be applicable to purchases made at merchant system 208). Additionally or alternatively, promotion sponsor system 204 and merchant system 208 may be operated by the same entity. For example, a merchant associated with merchant system 208 may be further associated with promotion sponsor system 204, and use promotion sponsor system 204 to initiate and manage a promotion. In some embodiments, a promotion sponsor may have a social networking profile with social networking system 206 and utilize the social networking profile to manage one or more aspects of a promotion being provided to user 212 by logging into social networking system 206.

Social networking system 206 may be configured to provide one or more social networking services to a plurality of users. In particular, social networking system 206 may be configured to allow user 212 and one or more social networking contacts 214-1 through 214-N (collectively referred to herein as “contacts 214”) of user 212 to interact with each other by way social networking system 206. In one or more embodiments, social networking system 206 may utilize information regarding the social networking activity of user 212 and other users of social networking system 206 to dynamically process payment authorization requests, as described in more detail herein.

Merchant system 208 may be associated with a particular merchant and may be configured to send payment authorization requests to authorization processing system 202. For example, merchant system 208 may include a point-of-sale system for initiating payment authorization requests (e.g., including a payment card reader associated with one or more credit card networks). In response to user 212 using a gift card (e.g., a gift card issued by social networking system 206) at merchant system 208, merchant system 208 may send a payment authorization request to authorization processing system 202 (e.g., by way of a credit card network, such as the Discover™ network) for processing and/or approval. Along with the payment authorization request, merchant system 208 may send any suitable information necessary or helpful in processing the payment authorization request. For example, the payment authorization request may include and/or be accompanied with information identifying a merchant (e.g., a merchant ID) associated with merchant system 208, information regarding the amount of the payment to be authorized, time and/or date information associated with the purchase, categorical information associated with the purchase, a geographic location of merchant system 208, and/or any other suitable information associated with the purchase. As used herein, the term “categorical information” may refer to information indicating a category associated with a particular purchase and/or merchant. For example, “categorical information” may include information indicating that a particular merchant is included in a particular category of merchants (e.g., “restaurants”) and/or that a particular purchase is included in a particular category of purchases (e.g., “dining out”).

Authorization processing system 202 may utilize promotional information received from promotion sponsor system 204, social networking information received from social networking system 206, and/or information received from merchant system 208 to dynamically process a payment authorization request. In particular, authorization processing system 202 may utilize the received information to detect one or more triggers associated with the payment authorization request and then process (e.g., approve or deny) the payment authorization request in accordance with any detected triggers. To illustrate, based on the received information and/or one or more detected triggers, authorization processing system 202 may apply one or more available promotional values and/or one or more overspend values to authorize a requested purchase in response to the payment authorization request. Accordingly, authorization processing system 202 may dynamically reply to payment authorization requests on the backend in a way that is seamless to merchant system 208 and/or user 212, and without the need to apply a promotion or overspend authorization (e.g., a split-tender) at merchant system 208.

The following is provided to illustrate an exemplary operation of implementation 200: Promotion sponsor system 204 may provide information associated with a promotion to authorization processing system 202 and/or social networking system 206. The promotion information may include information identifying a promotional value and one or more conditions that must be satisfied before the promotional value becomes available. For example, the promotional conditions may require that user 212 utilize social networking system 206 to check in to a location associated with merchant system 208 with at least two other people and make a purchase of at least $50. If the conditions of the promotion are met, then a promotional value of $10 may be applied to a qualifying purchase. User 212 may qualify for the promotion by checking in to the location associated with merchant system 208 along with contacts 214, and making a purchase of at least $50 using a gift card having a stored value associated with merchant system 208. Authorization processing system 202 may utilize this information to determine that the promotional conditions have been satisfied. In some embodiments, this determination may be made in response to and after receiving the payment authorization request from merchant system 208 (e.g., rather than beforehand). Authorization processing system 202 may then apply the promotional value of $10 to the $50 purchase. Authorization processing system 202 may further apply a stored value on the gift card to cover the remaining $40. If the stored value is insufficient to cover the remaining $40, authorization processing system 202 may perform one or more steps to determine whether user 212 qualifies for an overspend authorization, as explained in more detail herein. Once authorization processing system 202 has determined that sufficient funds (e.g., in the form of a stored value, a promotional value, an overspend value, or any combination thereof) are available to cover the $50 purchase, authorization processing system 202 may send a payment authorization to merchant system 208, after which merchant system 208 may complete the transaction.

In one or more embodiments, system 100 may be implemented entirely by or within authorization processing system 202. In other embodiments, components of system 100 may be distributed across authorization processing system 202 and social networking system 206. Although authorization processing system 202 and social networking system 206 are shown as separate systems in FIG. 2, in yet further embodiments, authorization processing system 202 may be integrated within social networking system 206. Accordingly, social networking system 206 may be configured to perform all of the features of system 100 and/or authorization processing system 202. Additionally, although promotion sponsor system 204 and merchant system 208 are shown as separate systems in FIG. 2, in some embodiments promotion sponsor system 204 may be integrated within merchant system 208. In particular, promotion sponsor system 204 and merchant system 208 may be associated with a single merchant. In yet further embodiments, components of system 100 may be distributed across authorization processing system 202, promotion sponsor system 204, social networking system 206, and/or merchant system 208 in any other suitable manner.

Each of authorization processing system 202, promotion sponsor system 204, social networking system 206, and/or merchant system 208 may be implemented by one or more computing devices, such as one or more server devices. Additionally or alternatively, authorization processing system 202, promotion sponsor system 204, social networking system 206, and/or merchant system 208 may each be implemented by another suitable device, including but not limited to, a mobile access device (e.g., a mobile phone device, a handheld device, a laptop computer, a tablet computer, a personal-digital assistant device, etc.), a personal computer, a point-of-sale device, and/or any other device configured to perform one or more of the processes and/or operations described herein.

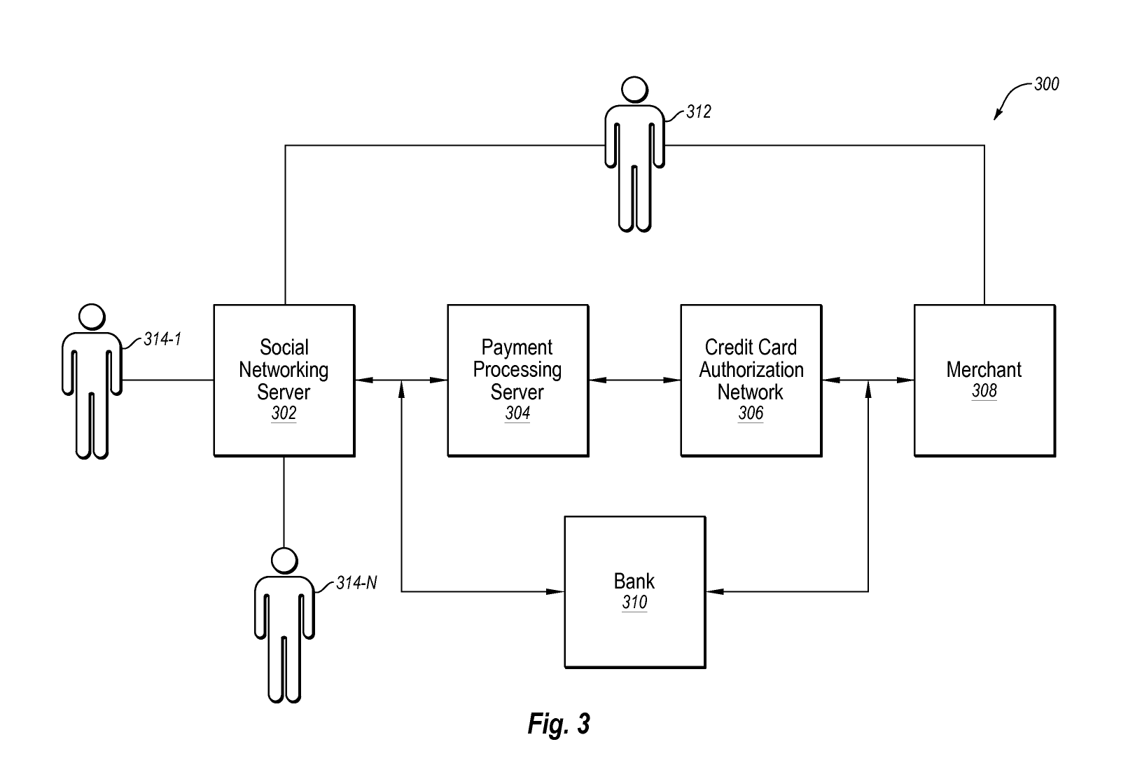

FIG. 3 shows another exemplary implementation 300 of system 100 including a social networking server (or servers) 302, a payment processing server 304, a credit card authorization network 306, a merchant 308, and a bank 310 in communication by way of one or more communicational links Implementation 300 also includes a user 312 and a plurality of social networking “friends” 314-1 through 314-N (collectively referred to herein as “friends 314”) associated with social networking server 302. One or more components of system 100 may be implemented by social networking server 302 and/or payment processing server 304. For example, social networking server 302 (independent of or in conjunction with payment processing server) may be configured to issue a gift card to user 312. The gift card may include one or more stored values, one or more promotional values, and/or one or more overspend values. In particular, the gift card of user 312 may include stored values representing gifts given to user 312 by friends 314. At least one of the stored values on the gift card may be associated with merchant 308. Merchant 308 may be a merchant with a physical location and/or an e-commerce website or native e-commerce application. User 312 may choose to use the gift card to make a purchase at merchant 308. In response to a use of the gift card at merchant 308, merchant 308 may send a payment authorization request by way of credit card authorization network 306. Credit card authorization network 306 may be any suitable credit card authorization network. In some embodiments, the gift card may be designated for use with a particular credit card authorization network 306. Credit card authorization network 306 may be configured to facilitate the payment authorization process and/or a corresponding settlement process. In particular, credit card authorization network 306 may facilitate delivery of a payment authorization request from merchant 308 to social networking server 302 or payment processing server 304 and/or facilitate receipt of a response to the payment authorization request from social networking server 302 or payment processing server 304. Processing a payment authorization request, whether by social networking server 302 or payment processing server 304, may implement one or more of the principles or features described for processing payment authorization requests, such as those discussed with respect to system 100 and implementation 200.

Once a purchase by user 312 at merchant 308 has been authorized, social networking server 302 and/or payment processing server 304 may settle the gift card transaction with merchant 308 by way of bank 310 and/or credit card authorization network 306. In particular, social networking server 302 may direct bank 310 to transfer funds for the purchase to merchant 308 or a financial institution associated with merchant 308.

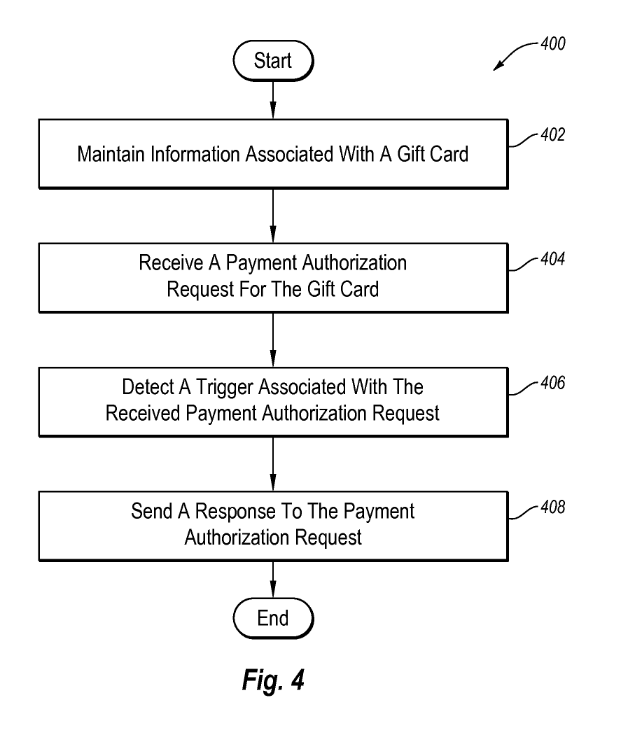

FIG. 4 illustrates an exemplary method 400 of dynamically processing payment authorization requests. While FIG. 4 illustrates exemplary steps according to one embodiment, other embodiments may omit, add to, reorder, and/or modify any of the steps shown in FIG. 4. One or more of the steps shown in FIG. 4 may be performed by any component or combination of components of system 100.

Step 402 may include maintaining information associated with a gift card. In particular, step 402 may include maintaining information associated with a gift card, wherein the information associated with the gift card comprises one or more stored values associated with one or more merchants, and wherein the gift card is issued to a user of a social networking system. For example, gift card management module 102 may be configured to maintain any information associated with a gift card or a plurality of gift cards in any suitable manner, such as described herein. To illustrate, gift card management module 102 may be configured to maintain information associated with stored values on a gift card, merchants where the stored values may be used, promotions available through use of the gift card, and/or overspend authorization information for the gift card, as well has any other information related to gift cards, such as described herein.

Step 404 may include receiving a payment authorization for a gift card. In particular, step 404 may include receiving a payment authorization request for the gift card from a particular merchant, wherein the authorization request specifies a payment amount for a purchase being made with the gift card. For example, the payment authorization request may be received from a merchant in response to a use of a gift card at the merchant. In particular, payment authorization module 106 may be configured to receive the payment authorization request in any suitable manner.

Step 406 may include detecting a trigger associated with the received payment authorization request. For example, trigger detection module 104 may be configured to detect the trigger in any suitable manner, such as described herein. In some examples, the trigger may be associated with a particular promotion associated with the gift card and/or available to a user of the gift card. Detecting the trigger may comprise determining whether one or more conditions associated with the promotion have been satisfied.

Step 408 may include sending a response to the payment authorization request. For example, payment authorization module 106 may be configured to respond to the payment authorization request in any suitable manner, such as described herein. In one or more embodiments, the response to the payment authorization request may be based on or provided in response to the trigger detected in step 406. To illustrate, a positive response (e.g., a payment authorization) may be contingent on the detected trigger.

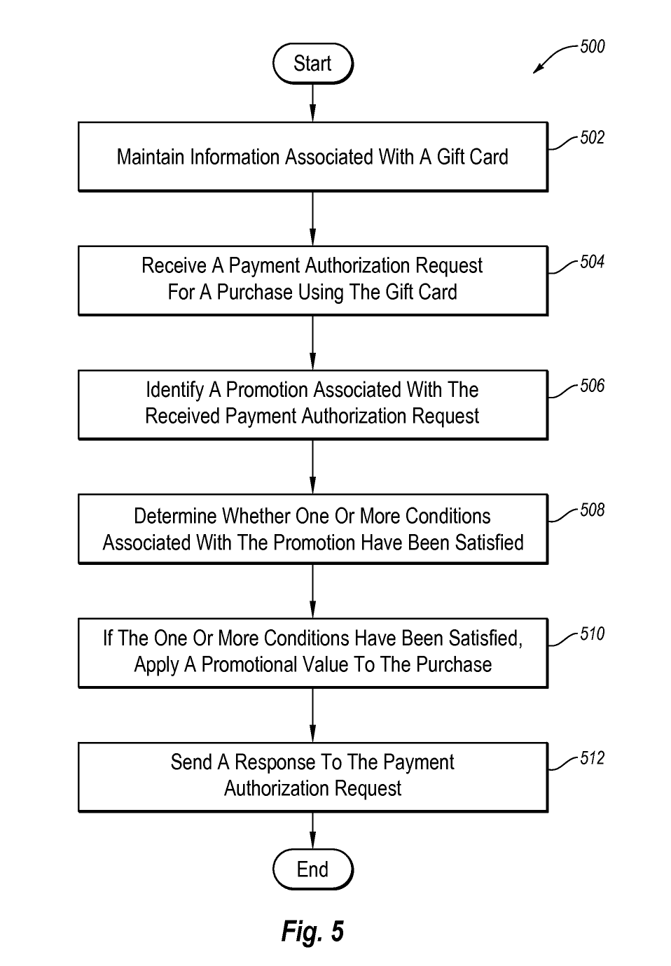

FIG. 5 illustrates another exemplary method 500 of dynamically processing payment authorization requests. While FIG. 5 illustrates exemplary steps according to one embodiment, other embodiments may omit, add to, reorder, and/or modify any of the steps shown in FIG. 5. One or more of the steps shown in FIG. 5 may be performed by any component or combination of components of system 100.

Step 502 may include maintaining information associated with a gift card. In particular, step 502 may include maintaining information associated with a gift card, wherein the information associated with the gift card comprises one or more stored values associated with one or more merchants, and wherein the gift card is issued to a user of a social networking system. For example, gift card management module 102 may be configured to maintain any information associated with a gift card or a plurality of gift cards in any suitable manner, such as described herein.

Step 504 includes receiving a payment authorization request for a purchase using the gift card. In particular, step 504 may include receiving a payment authorization request for the gift card from a particular merchant, wherein the authorization request specifies a payment amount for a purchase being made with the gift card. For example, the payment authorization request may be received from the particular merchant in response to a use (e.g., swiping the gift card using a payment card reader) of a gift card at the particular merchant. Payment authorization module 106 may be configured to receive the payment authorization request in any suitable manner.

Step 506 may include identifying a promotion associated with the received payment authorization request. For example, trigger detection module 104 may be configured to utilize information from the received payment authorization request to identify a promotion associated with the payment authorization request. To illustrate, trigger detection module 104 may utilize a merchant ID included with the payment authorization request to identify a promotion associated with a merchant identified by the merchant ID. Additionally or alternatively, trigger detection module 104 may identify one or more conditions associated with the identified promotion.

Step 508 may include determining whether one or more conditions associated with the identified promotion have been satisfied. For example, trigger detection module 104 may determine whether the one or more conditions associated with the promotion have been satisfied. The determination may be made using any available information associated with the user and/or the payment authorization request. For example, trigger module 104 may use information associated with social networking activity of the user and details of the requested purchase to determine whether the one or more conditions associated with the promotion have been satisfied.

Step 510 may include applying a promotional value to the purchase if the one or more conditions have been satisfied. For example, payment authorization module 106 may be configured to apply the promotional value towards the purchase in any suitable manner, such as described herein.

Step 512 may include sending a response to the payment authorization request. For example, payment authorization module 106 may be configured to respond to the payment authorization request in any suitable manner, such as described herein. The response may either be an authorization of the payment or a denial of the payment authorization. In one or more embodiments, the response to the payment authorization request may be based on the terms and conditions associated with the promotion.

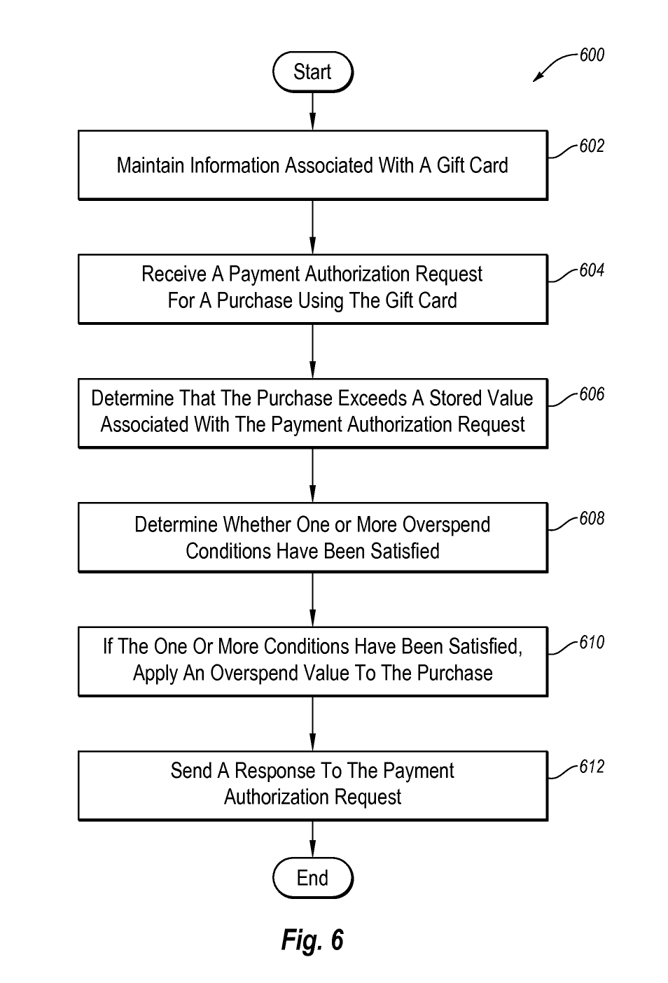

FIG. 6 illustrates a further exemplary method 600 of dynamically processing payment authorization requests. While FIG. 6 illustrates exemplary steps according to one embodiment, other embodiments may omit, add to, reorder, and/or modify any of the steps shown in FIG. 6. One or more of the steps shown in FIG. 6 may be performed by any component or combination of components of system 100.

Step 602 may include maintaining information associated with a gift card. In particular, step 602 may include maintaining information associated with a gift card, wherein the information associated with the gift card comprises one or more stored values associated with one or more merchants, and wherein the gift card is issued to a user of a social networking system. For example, gift card management module 102 may be configured to maintain any information associated with a gift card or a plurality of gift cards in any suitable manner, such as described herein.

Step 604 may include receiving a payment authorization request for a purchase using the gift card. In particular, step 604 may include receiving a payment authorization request for the gift card from a particular merchant, wherein the authorization request specifies a payment amount for a purchase being made with the gift card. For example, the payment authorization request may be received from a merchant in response to a use of the gift card at the merchant. Payment authorization module 106 may be configured to receive the payment authorization request in any suitable manner.

Step 606 may include determining that the purchase exceeds a stored value associated with the payment authorization request. For example, payment authorization module 106 may be configured to determine that the purchase exceeds a corresponding stored value in any suitable manner, such as described herein.

Step 608 may include determining whether one or more overspend conditions have been satisfied. For example, trigger detection module 104 may determine whether the one or more overspend conditions have been satisfied. To illustrate, trigger detection module 104 may determine whether an overspend value and/or an alternative funding source (e.g., a credit card, a bank account) is available to cover the overspend amount.

Step 610 may include applying an overspend value to the purchase if the one or more conditions have been satisfied. For example, payment authorization module 106 may be configured to apply an available overspend value to the purchase to cover the overspend amount. In additional or alternative embodiments, payment authorization module 106 may be configured send a payment authorization request for a credit card of the user to cover the overspend amount.

Step 612 may include sending a response to the payment authorization request. For example, payment authorization module 106 may be configured to respond to the payment authorization request in any suitable manner, such as described herein. In one or more embodiments, payment authorization module 106 may approve the payment authorization if an overspend value is available to cover the overspend amount.

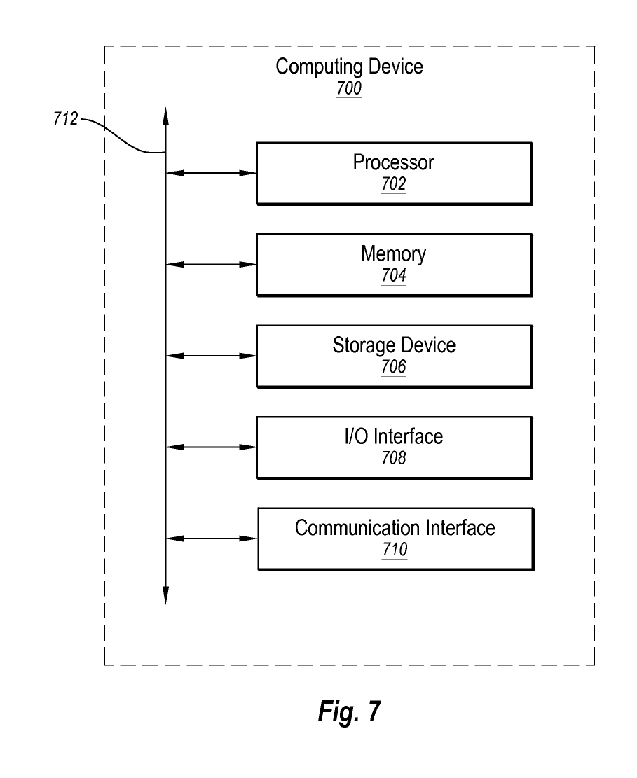

FIG. 7 illustrates, in block diagram form, an exemplary computing device 700 that may be configured to perform one or more of the processes described above. One will appreciate that system 100, authorization processing system 202, promotion sponsor system 204, social networking system 206, merchant system 208, social networking server 302, and/or payment processing server 304 may each comprise one or more computing devices in accordance with implementations of computing device 700. As shown by FIG. 7, the computing device can comprise a processor 702, a memory 704, a storage device 706, an I/O interface 708, and a communication interface 710, which may be communicatively coupled by way of communication infrastructure 712. While an exemplary computing device 700 is shown in FIG. 7, the components illustrated in FIG. 7 are not intended to be limiting. Additional or alternative components may be used in other embodiments. Furthermore, in certain embodiments, a computing device 700 can include fewer components than those shown in FIG. 7. Components of computing device 700 shown in FIG. 7 will now be described in additional detail.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage device 706 and decode and execute them. In particular embodiments, processor 702 may include one or more internal caches for data, instructions, or addresses. As an example and not by way of limitation, processor 702 may include one or more instruction caches, one or more data caches, and one or more translation lookaside buffers (TLBs). Instructions in the instruction caches may be copies of instructions in memory 704 or storage 706.

Memory 704 may be used for storing data, metadata, and programs for execution by the processor(s). Memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 704 may be internal or distributed memory.

Storage device 706 includes storage for storing data or instructions. As an example and not by way of limitation, storage device 706 can comprise a non-transitory storage medium described above. Storage device 706 may include a hard disk drive (HDD), a floppy disk drive, flash memory, an optical disc, a magneto-optical disc, magnetic tape, or a Universal Serial Bus (USB) drive or a combination of two or more of these. Storage device 706 may include removable or non-removable (or fixed) media, where appropriate. Storage device 706 may be internal or external to the computing device 700. In particular embodiments, storage device 706 is non-volatile, solid-state memory. In other embodiments, Storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 708 allows a user to provide input to, receive output from, and otherwise transfer data to and receive data from computing device 700. I/O interface 708 may include a mouse, a keypad or a keyboard, a touch screen, a camera, an optical scanner, network interface, modem, other known I/O devices or a combination of such I/O interfaces. I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 708 is configured to provide graphical data to a display for presentation to a user. The graphical data may be representative of one or more graphical user interfaces and/or any other graphical content as may serve a particular implementation.

Communication interface 710 can include hardware, software, or both. In any event, communication interface 710 can provide one or more interfaces for communication (such as, for example, packet-based communication) between computing device 700 and one or more other computing devices or networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Communication infrastructure 712 may include hardware, software, or both that couples components of computing device 700 to each other. As an example and not by way of limitation, communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof

As mentioned above, system 100 may be linked to and/or implemented within a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social-networking system a request to create an edge between a user node of the user and a concept node of the concept, indicating a relationship between the user and the concept (e.g., the user checks in to a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia files to a user's profile page (typically known as “wall posts” or “timeline posts”) or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similarly to events, the calendar entries may include times, dates, locations and identities of other users.

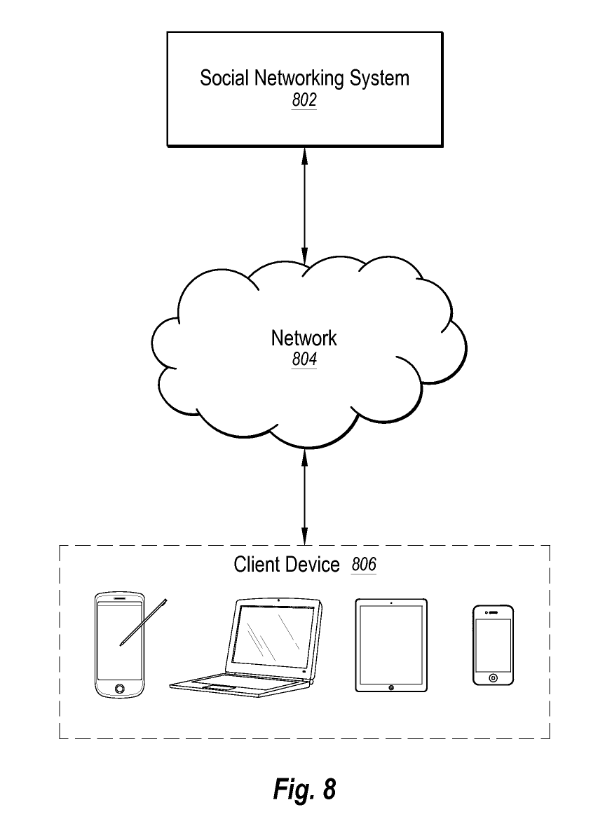

FIG. 8 illustrates an example network environment of a social-networking system. In particular embodiments, a social-networking system 802 may comprise one or more data stores. In particular embodiments, the social-networking system 802 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social-networking system 802 may comprise one or more computing devices (e.g., servers) hosting functionality directed to operation of the social-networking system 802. A user of the social-networking system 802 may access the social-networking system 802 using a client device such as client device 806. In particular embodiments, the client device 806 can interact with the social-networking system 802 through a network 804.

The client device 806 may be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 806 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 804.

Network 804 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 806 may access the social-networking system 802.

While these methods, systems, and user interfaces utilize both publicly available information as well as information provided by users of the social-networking system, all use of such information is to be explicitly subject to all privacy settings of the involved users and the privacy policy of the social-networking system as a whole.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
maintaining information associated with a gift card, wherein the information associated with the gift card comprises one or more stored values associated with one or more merchants, and wherein the gift card is issued to a user of a social networking system;
receiving a payment authorization request for the gift card from a particular merchant, wherein the authorization request specifies a payment amount for a purchase being made with the gift card;
detecting, using at least one processor, a trigger associated with the received payment authorization request; and
sending, based on the detected trigger, a response to the payment authorization request.

2. The method of claim 1, further comprising identifying, from the one or more stored values, a stored value associated with the particular merchant.

3. The method of claim 2, further comprising determining that the stored value is less than the payment amount.

4. The method of claim 3, further comprising applying a promotional value towards the purchase.

5. The method of claim 4, further comprising:
determining whether a combination of the stored value and the promotional value exceeds the payment amount; and
sending a payment authorization in response to the determination that the combination of the stored value and the promotional value exceeds the payment amount.

6. The method of claim 4, further comprising prioritizing application of the promotional value over application of the stored value towards the payment amount.

7. The method of claim 4, further comprising:
deducting the promotional value from the payment amount; and
applying the stored value to cover a remainder of the payment amount.

8. The method of claim 1, wherein the trigger is associated with a promotion.

9. The method of claim 8, wherein detecting the trigger comprises detecting a satisfaction of one or more conditions associated with the promotion.

10. The method of claim 9, wherein detecting satisfaction of the one or more conditions associated with the promotion comprises detecting that the payment amount meets or exceeds a minimum purchase requirement.

11. The method of claim 9, wherein detecting satisfaction of the one or more conditions associated with the promotion comprises detecting that a time or a date of the purchase satisfies one or more time or date conditions associated with the promotion.

12. The method of claim 9, wherein detecting satisfaction of the one or more conditions associated with the promotion comprises detecting a social networking activity of the user.

13. The method of claim 12, wherein the social networking activity comprises at least one of liking the particular merchant, sharing content associated with the particular merchant, or checking in at a location associated with the particular merchant.

14. The method of claim 9, further comprising:
receiving information associated with the promotion from a promotion sponsor; and
making the promotion available to the user in accordance with the received information associated with the promotion.

15. The method of claim 1, wherein the trigger is associated with an overspend authorization.

16. The method of claim 15, wherein detecting the trigger comprises detecting that the user is authorized to spend more than a stored valued associated with the particular merchant.

17. The method of claim 15, wherein detecting the trigger comprises detecting an overspend value available to apply towards the purchase or alternative funding information associated with the particular merchant.

18. The method of claim 1, wherein the one or more stored values are representative of one or more gifts received by the user through the social networking system from one or more social networking contacts of the user.

19. A method comprising:
maintaining information associated with a gift card, wherein the information associated with the gift card comprises one or more stored values associated with one or more merchants, and wherein the gift card is issued to a user of a social networking system;
receiving a payment authorization request for the gift card from a particular merchant, wherein the authorization request specifies a payment amount for a purchase being made with the gift card;
identifying a promotion associated with the payment authorization request;
determining whether one or more conditions associated with the promotion have been satisfied;
if the one or more conditions have been satisfied, applying a promotional value associated with the promotion towards the payment amount; and
sending a response to the payment authorization request.

20. A method comprising:
maintaining information associated with a gift card, wherein the information associated with the gift card comprises one or more stored values associated with one or more merchants, and wherein the gift card is issued to a user of a social networking system;
receiving a payment authorization request for the gift card from a particular merchant, wherein the authorization request specifies a payment amount for a purchase being made with the gift card;
determining that the payment amount exceeds a stored value associated with the payment authorization request;
determining whether one or more overspend conditions have been satisfied;
if the one or more overspend conditions have been satisfied, applying an overspend value towards the payment amount; and
sending a response to the payment authorization request.
